(19) United States
(12) Patent Application Publication
(10) Pub. No.: US 2006/0097468 A1
(43) Pub. Date: May 11, 2006

(54) Wheeled X-frame table dolly

(76) Inventor: Albert J. Sugrue, Wapingers Falls, NY (US)

Correspondence Address: Richard C. Litman;LITMAN LAW OFFICES, LTD., P.O. Box 15035, Arlington, VA, 22215, US

(21) Appl. No.: 10/981,649

(22) Filed: Nov. 5, 2004

(51) Int. Cl. B62B 3/00

(52) U.S. Cl. 280/79.11

(57) ABSTRACT

The wheeled “X”-frame table dolly has a “U”-shaped guide member extending forwardly and rearwardly from a “U”-shaped cross member at a center point. The guide member has swivel castor wheels at its front and rear ends and at its center. The cross member has fixed castor wheels for its support. The cross member also has matching grooves and wing-nut fasteners for mounting extensions and varying their length on each side of the guide member so as to carry a variety of tables having differing widths between the end legs thereof. Extensions having fixed forward and rear directional castor wheels support the added weight. The extensions are withdrawn inward for compactness for storage. A folded table may also be carried on its side in the guide member as desired. Carpet portions or other padding are included to cover the carrying surfaces of the guiding member cross member and extensions.

### BACKGROUND OF THE INVENTION

1. Field of the Invention

The present invention relates to moving dollys. More particularly, the present invention relates an “X”-frame dolly for moving tables or chairs.

2. Description of the Related Art

The use of platform dollys having castor-type wheels for moving furniture or goods is widespread. One problem with such dollys is that they are necessarily bulky and difficult to maneuver when made sufficiently large to carry the end legs of a table or a table on its side. The “X”-frame design for dollys reduces the bulk and weight of the dolly while remaining useful for carrying the lower ends of furniture. In this case two dollys are generally needed to support each end of the furniture. A single “X”-frame dolly is generally sized to carry an oil drum or trash can.

Typically, all of the castor wheels or the like on such a dolly are swivel castors which swivel to roll in any direction relative to the dolly frame. This presents a problem in steering and maneuvering the dolly under load in that it is difficult to get all the wheels to swivel into the correct position to carry a load in a desired change in direction.

It would be desirable to provide a dolly having the advantages of an “X”-frame configuration which easily carries the end legs of a table, enabling the mover to pick up the table at the other end and maneuver the dolly and table, much like a wheelbarrow. It would also be desirable to provide such a dolly which is adjustable such that table legs or the like that are spread apart a substantial distance may also be moved in a like manner. It would further be desirable if such a dolly were useful in carrying a table on its side.

None of the above inventions and patents, taken either singly or in combination, is seen to describe the instant invention as claimed. Thus a wheeled x-frame table dolly solving the aforementioned problems is desired.

### SUMMARY OF THE INVENTION

The wheeled “X”-frame table dolly of the present invention includes a “U”-shaped guide member extending forwardly and rearwardly from a “U”-shaped cross member at a center point. The guide member has swivel castor wheels at its front and rear ends and at its center. The cross member has fixed castor wheels for its support. The cross member also has matching grooves and wing-nut fasteners for mounting extensions and varying their length on each side of the guide member so as to carry a variety of tables having differing widths between the end legs thereof. For particularly wide table leg widths, extensions are provided having fixed forward and rear directional castor wheels to support the added weight. The extensions may be withdrawn inward for compactness for storage or for use with tables with a narrow end leg spread. A folded folding table may also be carried on its side in the guide member as desired.

Carpet portions or other padding are included to cover the carrying surfaces of the guiding member cross member and extensions. The combination of unidirectional fixed castor wheels on the ends of the cross members while providing multi-directional swivel castor wheels along the guide member make steering or maneuvering the loaded dolly easy in that it maneuvers much like a wheelbarrow. The inventive dolly may also be used to move a stack of stackable chairs, the front legs of the lowest chair being supported on the cross member of the dolly and the stack being rotated upward and pushed forward with the dolly by a mover.

It is an aspect of the invention to include improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1A is an environmental, perspective view of a wheeled “X”-frame table dolly according to the present invention.

FIG. 1B is a perspective view of the table dolly of FIG. 1A with the carpet portions removed showing the small extensions in the withdrawn position.

FIG. 2 is an inverted perspective view of the table dolly of FIG. 1B.

FIG. 3 is an environmental, perspective view of the table dolly of FIG. 1B with the small extensions extended to carry the legs of a folding round table.

FIG. 4 is a perspective view of the table dolly of FIG. 1B having large extensions having separate support wheels and mounted in the withdrawn position.

FIG. 5 is an inverted perspective view of the table dolly of FIG. 4.

Similar reference characters denote corresponding features consistently throughout the attached drawings.

### DETAILED DESCRIPTION OF THE PREFERRED EMBODIMENTS

The present invention is a wheeled “X”-frame table dolly which includes an elongated “U”-shaped guide member extending forwardly and rearwardly from an elongated “U”-shaped cross member at a center point. The guide member has swivel castor wheels at its front and rear ends and at its center. The cross member has fixed forward and rear castor wheels.

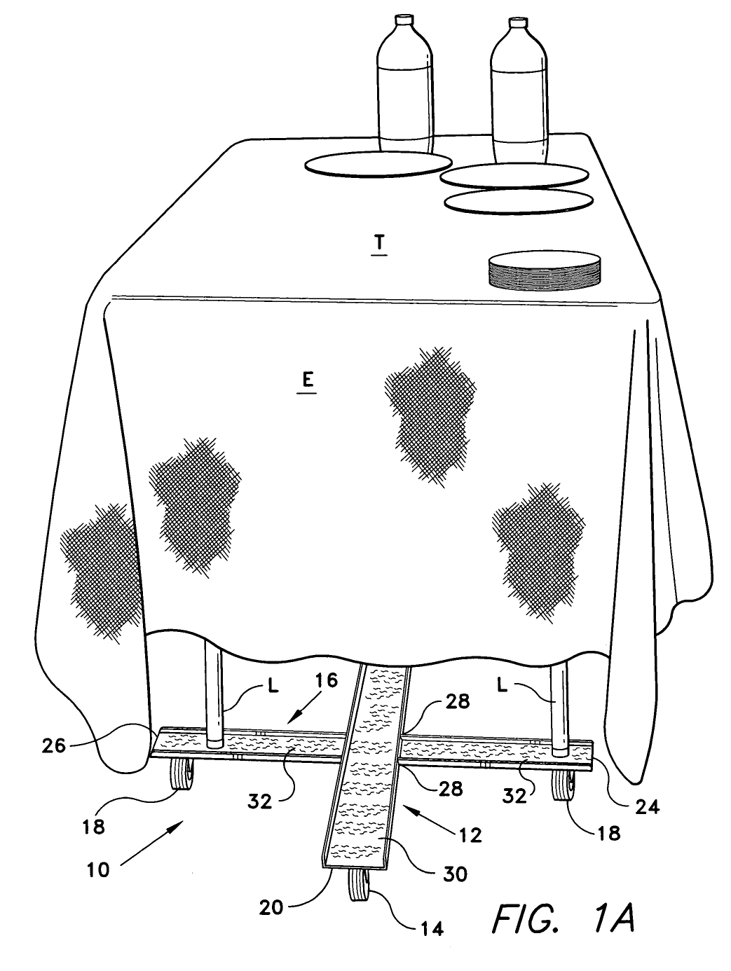

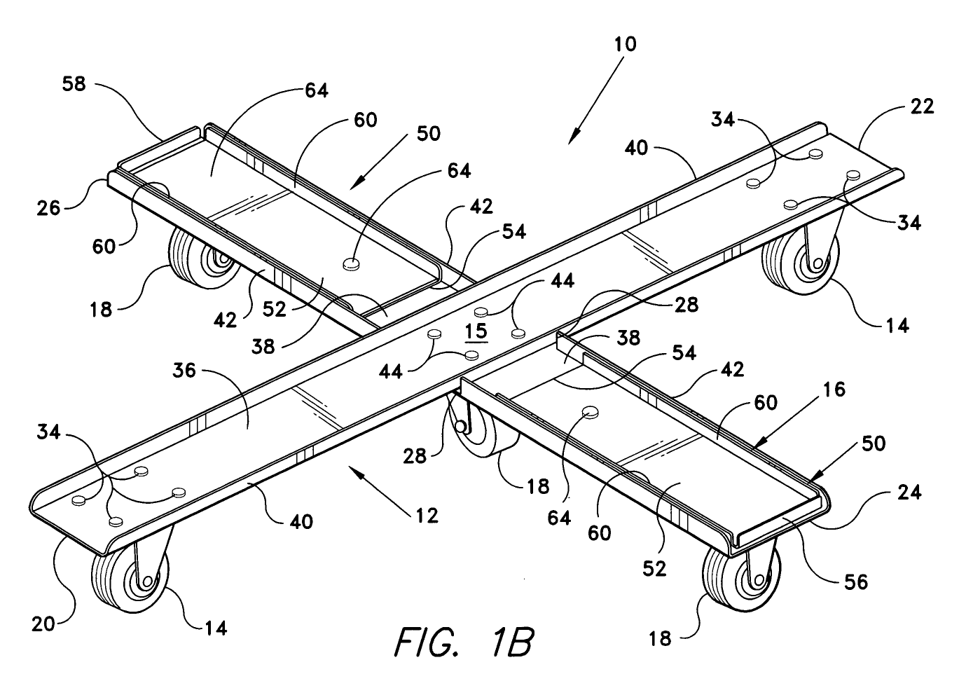

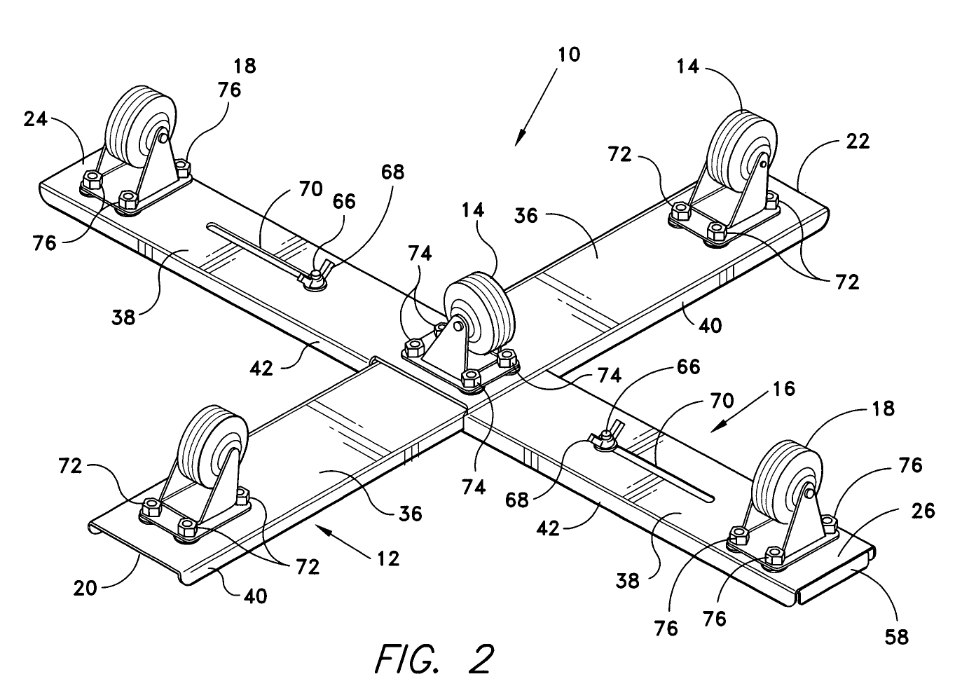

Referring to FIG. 1, there is shown an environmental, perspective view of the inventive “X”-frame table dolly system 10 having a guiding “U”-shaped member 12 mounted on swivel castors 14 mounted at its respective end portions and a cross “U”-shaped member 16 having fixed castors 18 mounted at its respective end portions. Guiding member 12 has a forward end portion 20 and a rear end portion 22 (see FIG. 2) at which swivel castors 14 are mounted and cross member 16 has a left end portion 24 and a right end portion 26 at which fixed castors 18 are mounted. Cross member 16 has center notches 28 to receive guiding member 12 and affix thereto (see FIG. 2) to form the cross. Guiding member 12 has a carpet padding portion 30 extending its length for padding purposes. Cross member 16 has two carpet padding portions 32 extending from the center for padding purposes. As shown, the legs L at the end E of table T rest within cross member 16 and table T may be easily moved and maneuvered by picking up the opposite end and pushing or pulling and guiding the table dolly system 10 in the manner of a wheelbarrow. It is noted that left and right and front and rear designations are made for description purposes, as the inventive table dolly may be symmetric as shown.

Referring to FIG. 1B and FIG. 2 there is shown an upper perspective view and a lower perspective view, respectively, of the table dolly system 10 of FIG. 1A. Dolly system 10 is shown with carpet portions 30 and 32 removed for illustration purposes. Guide member 12 has swivel castors 14 mounted at front end portion 20 and rear end portion 22 mounted by fasteners having heads 34, and a centrally mounted swivel castor 14 mounted by fasteners having heads 44 at its central portion 15. Guiding member 12 is elongated, generally rectangular, and has a lengthwise flat 36 and side lips 40 extending its length. Cross member 16 is elongated, generally rectangular, and has a flat 38 and side lips 42 extending its length. Side lips 42 have cross member center notches 28 cut therein at its central portion to receive the guiding member 12 at central portion 15 to form the cross configuration of the dolly system 10. The fasteners for centrally mounted swivel castor 14 also serve to fasten guiding member 12 and cross member 16 together.

Left and right extensions 50 are shown as identical, in a withdrawn position, generally rectangular in shape, and mounted on cross member 16 on each side of guiding member 12 and include flats 52 having inner ends 54, outer left end lip 56 and right end lip 58, respectively. Extensions 50 are elongated and have side lips 60 along their lengths. Extensions 50 slide within cross member 16 and are secured in a desired position in adjustment slot 70 (see FIG. 2) by adjustment fastener heads 64.

As best seen in FIG. 2, adjustment fasteners 66 have wing nuts 68 for alternate tightening and loosening of adjustment fasteners 66 within cross member adjustment grooves 70, for adjusting the amount of extension of extensions 50 as desired. Swivel castor fasteners and nuts 72 secure swivel castors 14 to respective end portions of guiding member 12. Center member and castor fasteners and nuts 74 secure guiding member 12 to cross member 16 and swivel castor 14. Cross member castor fasters and nuts 76 secure fixed castors 18 to respective end portions of cross member 16.

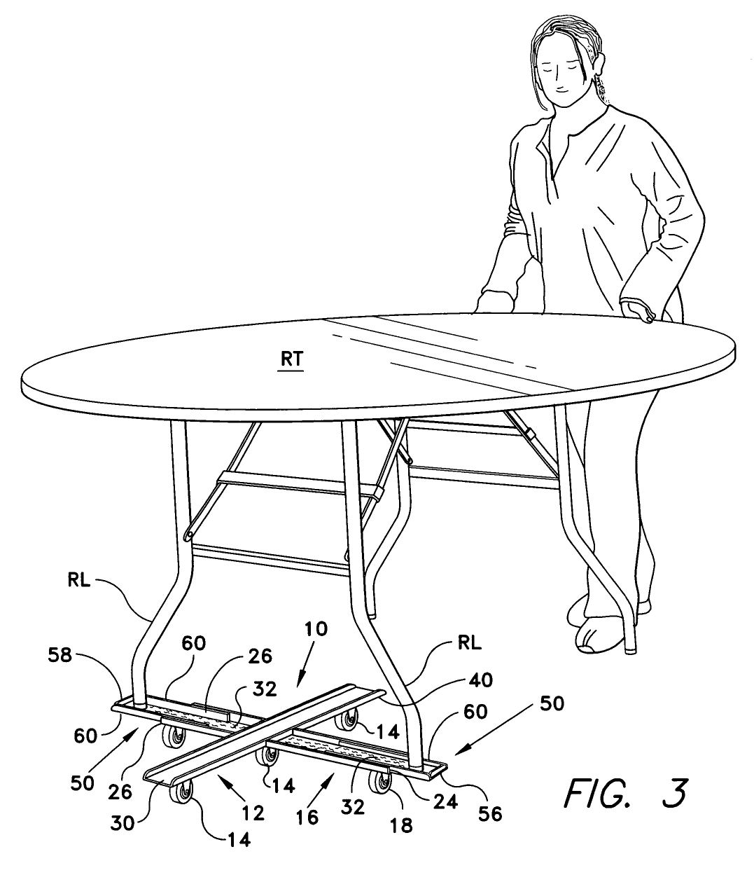

Referring to FIG. 3, there is shown an environmental perspective view of a person poised to lift and move a round table RT having flared legs RL in place on extensions 50 of cross members 16 of the table dolly system 10 of the present invention. As can be seen, fixed castors 18 allow easy forward and backward movement and may alternately serve as pivot points for the dolly system 10, while swivel castors 14 may turn into a curve as desired, simulating the handling of a wheelbarrow. Carpet portions 30 and 32 are in place in for protection of the legs of the table.

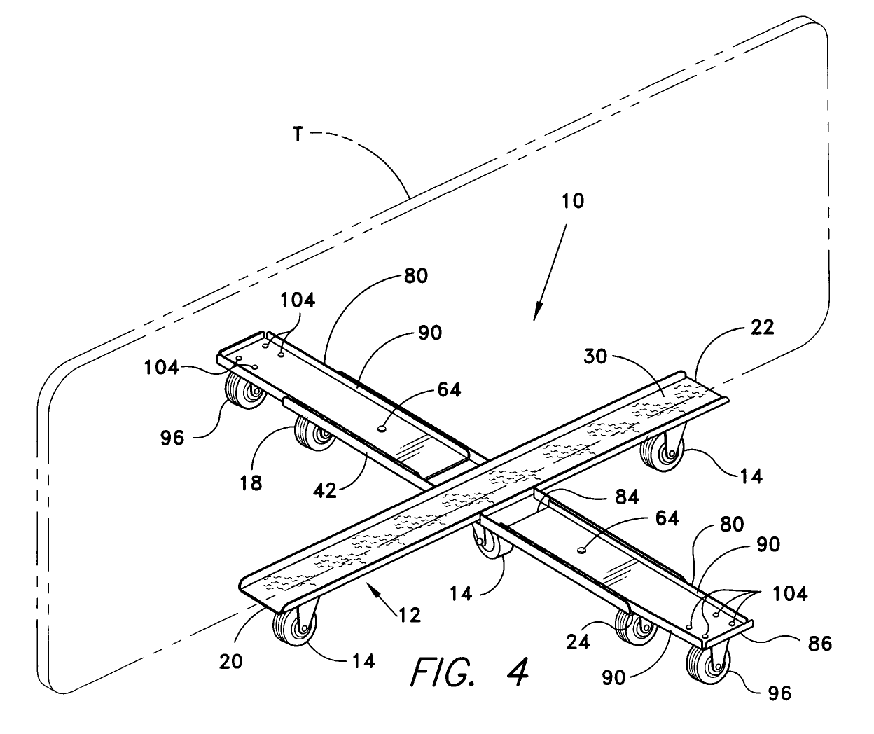

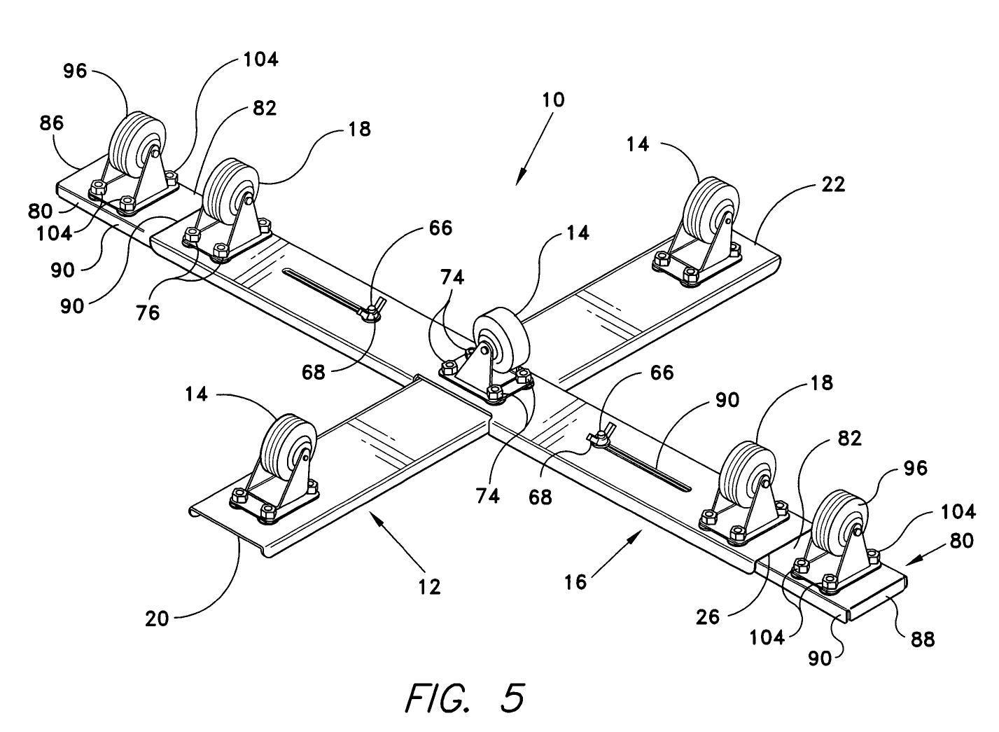

Referring to FIGS. 4 and 5, there is shown a perspective view of the table dolly system 10 in the upright and inverted positions, respectively, having wheeled extensions 80 substituted for the extensions 50 of FIG. 1A to FIG. 3. Wheeled extensions 80 are generally rectangular in shape and attached to cross member 16 by fasteners having heads 64 extending through extension flats 82. Wheeled extensions 80 have inner ends 84 and respective left end lip 86 and right end lip 88. Wheeled extensions 80 are elongated and have side lips 90 extending the length thereof. Fixed castors 96 are mounted on the respective outer end portions of wheeled extensions 80 by means of fasteners and nuts 104 and are mounted for forward and reverse movement parallel with said guide member 12.

As best seen in FIG. 5, flats 38 of cross member 16 define grooves 70 that receive adjustment fasteners 68 extending through flats 82, fastener heads 64 and wing nuts 66 acting on adjustment fasteners 68 for inward and outward adjustment of wheeled extenders 80. As is seen, wheeled extension fixed castors 96 are fastened to flats 82 at their respective end portions by fastener and nuts 104.

The “U”-shaped guide and cross members and the extensions are preferably made of steel ⅛ inch stamped steel sheet with the swivel and fixed castors being commercially available. The cross member is preferably 26 inches in length by 3 ⅛ inches wide with a lip height of ½ inch. The center slot cut for the guide member is 3⅜ inches in width. The extension adjustment slots in the cross member are preferably about 4 inches in length. The guide member is preferably 26 inches in length and 3⅛ inches wide with a lip height of ½ inch. The extensions 50 are preferably about 10 inches long by 3 inches wide having ½-inch side and end lips. The wheeled extensions 80 are preferably about 14 inches long by 3 inches wide with 1′ inch side and end lips.

It is to be understood that the present invention is not limited to the embodiments described above, but encompasses any and all embodiments within the scope of the following claims.

I claim:

1. A wheeled x-frame table dolly, comprising:
an elongated guide member having a front portion, a central portion and a rear portion;
an elongated cross member having a left portion, a central portion, and a right portion, said cross member central portion being perpendicularly attached to said central portion of said guide member;
said elongated guide member having a swivel castor wheel mounted to said front portion and said rear portion, respectively; and
said elongated cross member having a fixed castor wheel mounted on each of said left -portion and said right portion thereof, said fixed castor wheel being mounted for forward and reverse motion parallel with said guide member.

2. The table dolly of claim 1, further comprising a swivel castor wheel mounted at said central portion of said cross member at said guide member attachment thereto.

3. The table dolly of claim 2, wherein said elongate guide member is rectangular in shape, having lips extending upward along the sides thereof to form a generally “U”-shape.

4. The table dolly of claim 3, wherein said elongate cross member is rectangular in shape, having lips extending upward along the sides thereof to form a generally “U”-shape, said cross member lips having cutouts at the central portion thereof to receive said elongate guide member.

5. The table dolly of claim 4, further comprising extendable and retractable extensions mounted on said cross members extending from about said central portion to said respective end portions thereof.

6. The table dolly of claim 5, wherein said cross member define lengthwise adjustment grooves located between said central portion and said respective end portions and spaced therefrom, each said extendable and retractable extension having an adjustment screw extending therethrough at points spaced from said central portion, each said adjustment screw extending through a corresponding said adjustment groove for securing said extension at a desired extension point relative to said cross member.

7. The table dolly of claim 6, wherein each said adjustment screw has a thumb screw nut.

8. The table dolly of claim 6, wherein each said extension is generally rectangular, having sides an inner end and an outer end and having lips extending upward along the sides and outer end thereof.

9. The table dolly of claim 8, wherein each said extension outer end is about coextensive with the respective end portions of said cross member when in the retracted position.

10. The table dolly of claim 8, wherein each said extension outer end extends beyond the respective end portions of said cross member when in the retracted position, said extension outer end portions having fixed castor wheels mounted thereto and mounted parallel with said fixed castor wheels of said cross member outer end portions.

11. The table dolly of claim 8, further comprising a carpet padding portion fitting the length of and between said lips of said guide member, and carpet padding portions fitting at least the length of said extensions on said cross member.

12. A wheeled x-frame table dolly, comprising:
an elongated guide member having a front portion, a central portion and a rear portion;
an elongated cross member having a left portion, a central portion, and a right portion, said cross member central portion being perpendicularly attached to said central portion of said guide member;
said elongated guide member having a swivel castor wheel mounted to said front portion and said rear portion, respectively, and a swivel castor wheel mounted at said central portion of said cross member at said guide member attachment thereto; and
said elongated cross member having a fixed castor wheel mounted on each of said left portion and said right portion thereof, said fixed castor wheel being mounted for forward and reverse motion parallel with said guide member.

13. The table dolly of claim 2, wherein said elongate guide member is rectangular in shape, having lips extending upward along the sides thereof to form a generally “U”-shape, said elongate cross member being rectangular in shape, and having lips extending upward along the sides thereof to form a generally “U”-shape, said cross member lips having cutouts at the central portion thereof to receive said elongate guide member.

14. The table dolly of claim 12, further comprising extendable and retractable extensions mounted on said cross members extending from about said central portion to said respective end portions thereof.

15. The table dolly of claim 14, wherein said cross member defines lengthwise adjustment grooves located between said central portion and said respective end portions and spaced therefrom, each said extendable and retractable extension having an adjustment screw extending therethrough at points spaced from said central portion, each said adjustment screw extending through a corresponding said adjustment groove for securing said extension at a desired extension point relative to said cross member.

16. The table dolly of claim 15, wherein each said extension is generally rectangular, having sides an inner end and an outer end and having lips extending upward along the sides and outer end thereof.

17. The table dolly of claim 16, wherein each said extension outer end is about coextensive with the respective end portions of said cross member when in the retracted position.

18. The table dolly of claim 16, wherein each said extension outer end extends beyond the respective end portions of said cross member when in the retracted position, said extension outer end portions having fixed castor wheels mounted thereto and mounted parallel with said fixed castor wheels of said cross member outer end portions.

19. The table dolly of claim 16, further comprising a carpet padding portion fitting the length of and between said lips of said guide member, and carpet padding portions fitting at least the length of said extensions on said cross member.

20. A wheeled x-frame table dolly, comprising:
an elongated guide member having a front portion, a central portion and a rear portion;
an elongated cross member having a left portion, a central portion, and a right portion, said cross member central portion being perpendicularly attached to said central portion of said guide member;
said elongated guide member having a swivel castor wheel mounted to said front portion and said rear portion, respectively, and a swivel castor wheel mounted at said central portion of said cross member at said guide member attachment thereto; and
said elongated cross member having a fixed castor wheel mounted on each of said left portion and said right portion thereof, said fixed castor wheel being mounted for forward and reverse motion parallel with said guide member;
said elongate guide member being rectangular in shape, and having lips extending upward along the sides thereof to form a generally “U”-shape, said elongate cross member being rectangular in shape, and having lips extending upward along the sides thereof to form a generally “U”-shape, said cross member lips having cutouts at the central portion thereof to receive said elongate guide member; and
said table dolly further comprising extendable and retractable extensions mounted on said cross members extending from about said central portion to said respective end portions thereof.
